(19) United States
(12) Patent Application Publication
(10) Pub. No.: US 2017/0318753 A1
(43) Pub. Date: Nov. 9, 2017

(54) Plantlet Holder and Handling System

(71) Applicant: Nuplant Pty. Ltd., Toowong (AU)

(72) Inventor: Robert Dixon Teasdale, Toowong (AU)

(21) Appl. No.: 15/525,886

(22) PCT Filed: Nov. 11, 2015
(86) PCT No.: PCT/AU2015/050698

§ 371 Date: May 10, 2017

(30) Foreign Application Priority Data
Nov. 11, 2014 (AU) 2014904531

(51) Int. Cl. A01G 9/10; A01G 9/08

(52) U.S. Cl. CPC A01G 9/1033; A01G 9/1086; A01G 9/083; A01G 9/088; A01G 9/1066

(57) ABSTRACT

A plantlet holder (25) is formed of nutrient solution-absorbing, open celled, phenolic foam, with an upper handling portion (55), an insertion well (60) for a plantlet and a lower portion (56) adapted to laterally locate in a ring (30) in a work stand (24), the handling portion (55) adapted to be frictionally gripped for robotic or manual handling. Robotic handling apparatus includes a pair of plantlet holder gripper manipulator arms (40) adapted to engage the handling portion (55) for movement of a plantlet holder (25) between a material source portion, an operator work portion (14), and a material delivery portion. The operator work portion (14) is characterised by the work stands (24) locating the plantlet holders vertically by a step portion (32).

### FIELD OF THE INVENTION

This invention relates to a plantlet holder and a plantlet handling system in which it may be used. This invention has particular but not exclusive application to a robotic plantlet holder and a plantlet handling system for handling tissue cultured plantlets, and for illustrative purposes the invention will be described with reference to this application.

### BACKGROUND OF THE INVENTION

The reference to any prior art in this specification is not, and should not be taken as, an acknowledgement or any form of suggestion that the referenced prior art forms part of the common general knowledge in the relevant art.

Plant tissue culture typically involves growth of plants (including plantlets) under usually sterile conditions in nutrient medium in glass or plastic containers. Plantlets are typically grown in groups of up to 40 individual shoots per container. After a suitable period of growth, shoot pieces or small plantlets can be dissected from the plantlets to be placed in new medium so that these will form roots or shoot growth for ex vitro rooting, or other tissue growth and further grow. There are often more dissected pieces (shoot tips, nodal segments, or small plantlets) than in the original container. Moreover, the plantlets from which shoot pieces have been dissected will generally form new shoots that will grow and be suitable for dissection and planting. In these processes multiplication occurs.

In the transfer of propagated plant material between culture media or between growing environments, the transfer protocols must be selected to overcome the inherent weakness of plantlets in culture media. In WO 2009/021274 there is described a method including the steps of segregating plantlets from a tissue-culture propagation medium into a root-permeable container containing a phytocompatible supporting aqueous gel medium comprising a nutrient solution gelled with an effective amount of a hydrocolloid gel-forming material, acclimating the segregated plantlets in light and air until the roots extend to the bottom of the container, and planting out the acclimated plantlet in its container.

The described method provides advantages over the prior art of the time. However, the container requires support in a tube or the like that requires manual separation for planting out. Accordingly it would be desirable to provide a plantlet holder that can support the plantlet between culture steps or between the final stage of propagation and planting out directly in the container, and able to be handled mechanically.

International Application PCT/AU2010/001008 (WO 2011/014933) discloses a plantlet holder having a pair of apertures in one side disposed about a partition line, and a single large aperture in the opposite side again disposed symmetrically about the partition line. The base portions are also configured to close up forming a base aperture. Handling tabs in the assembled plantlet holder present single handling portions having opposed respective handling pegs, and are adapted to be gripped by a handling robot. The handling portion doubles as a means for positive orientation by engaging in use in the recess portion of the plantlet holder support.

An embodiment of the culture system includes a plantlet handling apparatus including a housing formed of a light-transmitting polypropylene, a plantlet holder support similarly moulded in polypropylene, a plurality of plantlet holders, and a closure assembly.

In the robotic handling of plantlets using the above described plantlet holders, the housing containing medium and plantlets is placed in a material source space in a robot workstation having a robotic arm and a second container or containers are located at a material delivery space in the workstation. The robotic arm is programmed to collect a plantlet holder or holders sequentially from the source container and/or a supply of holders, deliver the holder or holders to a worker for any one of several necessarily-manual tasks, and deliver the actioned holders to the container or containers in the delivery space. The robotic arm in terminated in a gripper assembly adapted to cooperate with the handling tabs. The handling tabs also cooperate with a handling stand to support the plantlet holder at the worker space of the workstation.

International Patent Publication No. WO2012167332 included variations on the themes of robotic handling, plantlet holders and manipulation of housing lids.

In each of these prior art arrangements, a reusable plantlet holder having a polymer body formed to an apertured, open-topped container is central. It is envisaged that a single-use plantlet holder would have benefits in terms of maintaining sterility, a condition for which the prior art plantlet holders would be uneconomic.

### SUMMARY OF THE INVENTION

In one aspect the present invention resides broadly in a plantlet holder formed of nutrient solution-absorbing material and comprising an upper portion with an insertion point at its top for inserting a plantlet and a lower portion adapted to locate in an opening in a support, the upper portion having an outer wall surface forming a handling portion adapted to be frictionally gripped for robotic or manual handling.

### DESCRIPTION OF THE INVENTION

The plantlet holder may be formed of any nutrient solution absorbing material including but not limited to natural or synthetic cellulosic fibrous materials, peat, polymer foam or the like. Where the plantlet holder is formed of fibrous materials, the plantlet holder may be moulded of the material using a phytocompatible binder to form an open topped, hollow plantlet holder having porous and nutrient solution absorbing walls. Alternatively a fibrous felted plantlet holder may be pierced by a hand tool to form the insertion point at its top for inserting a plantlet. Polymer foam plantlet holders are preferably formed of open celled materials and may be hollow or pierceable to form the insertion point at its top for inserting a plantlet.

The plantlet holder may be formed of an open-celled phenolic foam that readily absorbs nutrient solution selected from the type exemplified by florists foam used as a base for cut flower arrangements. Such foam may hold over 40 times its weight in water and is typified by that foam marketed as OASIS® Floral Foam.

The open celled nature of the foam and the hydrophilic nature of phenolic resin results in wicking or capillary action, which draws aqueous solutions to saturate the foam while there is solution available. The phenolic foam plantlet holder may be moulded with a plantlet insertion well in its upper end or may be pierceable to form the insertion point at its top for inserting a plantlet.

The plantlet holder lower portion may be adapted to be supported in a nutrient solution in a support, whereby the entire plantlet holder becomes saturated by capillary action. Accordingly the plantlet holder may be somewhat elongate along an axis running in the direction away from the plantlet insertion point. The plantlet holder may be symmetrical about one or most vertical planes including the axis. However, the plantlet holder may be asymmetric in at least one plane to accommodate arcuate movement in robotic handling as described hereinafter.

The plantlet holders may be formed as a matrix comprising a plurality of plantlet holders interconnected by frangible webs. In the case of the phenolic foam plantlet holders a relatively thin foam web may bind, for example, 24 foam plantlet holders in a rectangular array. The plantlet holders may be adapted for use in a housing containing nutrient solution as described hereinafter. In this example, the housing may be provided with a plurality of wells. On insertion of the matrix in the housing, the individual holders are separated from the matrix by the wedging action of differential spacing between the wells and the respective plantlet holders breaking the webs.

The lower portion may be adapted to locate in an opening in a support by any suitable location means. Where the support is for example a support body including an aperture adapted to receive the lower end of the plantlet holder the location mean may include a tapered portion of the lower portion adapted to bind in the aperture. Alternatively, the lower portion may be separated from the upper portion by a stopper portion or land adapted to engage the periphery of the aperture. For example, in the case of the phenolic foam plantlet holders formed as a matrix as described above, the residual frangible web about each plantlet holder may comprise a stopper portion or land adapted to engage the periphery of the aperture.

The handling portion and lower portion may be mutually formed as an integral body of constant cross section extending from the upper end, the lower portion having a lower end adapted to locate on a step portion associated with the support. The constant cross section may be rectilinear.

The handling portion may be adapted for robotic or manual handling. For example, the handling portion may be a plain cylindrical section or may be polygonal to provide for positive rotational location in orientation by robotic handling means. The surface of the handling portion may be textured, treated or coated to enhance handling grip. The handling portion may be formed of phenolic foam and comprise a frangible surface which is able to be keyed in to by gripping means associated with robotic or manual handling apparatus.

An important feature of automated and manual handling is to amass multiple plantlet holders in a housing that can both order the plantlet holders and maintain immersion in nutrient solution in use. In practice the housing should be closable by a lid having a complementary engagement periphery adapted to mechanically and sealingly engage a corresponding peripheral lip of the housing to provide an enclosure in which sterility may be maintained.

The housing may be formed of any material compatible for use in conjunction with plantlet raising conditions and media. For example the housing may comprise a polypropylene tub or tray. The housing is preferably transparent or translucent. For example the housing may be made of food grade polypropylene such as that used to produce take-away food containers. The housing may include integrally formed sealing means adapted to cooperate with the lid to provide the substantially airtight seal.

The housing may include an integral plantlet holder support. For example the housing may be formed with integral wells each configured to support a plantlet holder.

The housing may comprise a substantially flat bottomed enclosure for the nutrient medium and into which the supported plantlet holders depend. The void volume of nutrient medium between plantlet holders may be controlled by the use of integrally moulded void filler portions. Alternatively the housing base may be provided with re-entrants to enable close stacking of housings with the plantlet holder support and plantlet holders installed. For example the housing base may be formed with integral recesses adapted to cooperate with upper portions of the plantlet holders whereby the upper portions are located in the integral recesses in the stack.

The closure may comprise any suitable lid adapted to close off an open top of the housing by means of a substantially airtight seal. For example the closure may comprise a lid having a complementary engagement periphery adapted to mechanically and sealingly engage a corresponding peripheral lip of the housing. In the case of the polypropylene housings described above, the common and well developed technology in respect of sealing mechanical closure of take-away food containers may be utilized.

The maintenance of an isolated environment inside the housing by way of the mechanical seal between the housing and the closure is of course compromised by opening the housing. The closure may from time to time be opened. While the acclimation environment may be kept as clean as possible, contamination may occur. It has been surprisingly determined that contamination is reduced by providing the closure with a relatively deep peripheral flange that extends downward of the housing lip to define an annular dead space that is not subject to convection mixing with the environment. The flange appears to lower the risk of contamination by influencing the flow of condensation and airborne aerosols and particles entering the housing.

In a typical plantlet culture environment, a suitable flange may extend below the sealing rim of the housing sufficient to form an air gap which may avoid capillary entrapment of a water bridge across the seal. For example, the flange may extend at least 3 mm and preferably 8 to 10 mm). Preferably the annular space is narrow enough to achieve the desired convection mixing control but not so narrow as to form a surface tension trap for condensation. Where a deeper flange is preferred, there may be mechanical constraints such as the need to distort the flange by a sufficient degree to open the housing. In these cases the flange may be stepped whereby the selected narrow annular space is bounded at is lower edge by an outward step to a lower flange portion, whereby there is provided a lower annular space providing a degree of reduced convection mixing and of a width sufficient to permit removal of the closure from the housing and an upper annular space selected to substantially resist convection mixing.

The closure may have a peripheral flange that is spaced inwardly of and extends downward of the housing lip to define an annular drip line for condensation away from the lip. By this means the seal between the housing and closure does not attract and retain liquid condensate as a conduit for contamination.

The closure may have its selected permeability to metabolic gases produced or required by plantlets provided by inclusion of a gas permeable portion of the closure. Preferably the closure for said housing includes a gas permeable portion of either film material or fibrous material selected to allow exchange of metabolic gases produced or required by plantlets. The material may be hydrophobic or hydrophilic. For example, film materials may be selected from hydrophobic polyolefin materials. Fibrous materials may comprise hydrophilic or hydrophobic fibres in a woven or non-woven mat. There may be provided a cellulosic non-woven material having a proportion of polyolefin fibre therein to permit the mat to be heat sealed to a substrate such as the closure body.

Hydrophobic permeability of the closure to metabolic gases may be provided by any suitable means. By hydrophobic permeability to metabolic gases it is meant that metabolically relevant transfer of metabolic gases such as CO₂ and O₂ may relatively freely exchange through the closure. The material may be selected for its ability to control water vapour to tend water to be retained inside the housing. For example, there may be provided a closure including an annular body adapted to seal the housing closed and including a permeable closure portion closing over the aperture of the annulus and formed of a gas permeable hydrophobic material.

The gas permeable hydrophobic material may be selected from axially oriented crystalline polyolefins and other suitable membranous materials, and non-woven sheet materials. For example the hydrophobically permeable material may be selected from the synthetic materials, PP (Polypropylene), LDPE (low density polyethylene film), PVC (unplasticized polyvinylchloride film) and FEPC (fluorinated ethylene propylene copolymer film). An example of a non-woven hydrophilic material for making a relatively freely venting cover is KIMGUARD® microspun polypropylene fibre mat.

The gas permeable hydrophilic material may be selected from non-woven fibrous sheet materials, such as cellulose fibres with inclusion of a proportion of polyolefins to allow heat-sealing to the closure. The fibrous materials are selected to allow relatively free transfer of all gases, including water vapour, through the sheet material, but represent a tortuous path inhibiting the entry of particulate biological contaminants.

The permeable portion may be mechanically engaged with a body portion of the closure, or may be adhered to the closure body by adhesive or heat sealing. In the case of a moulded polymer closure, the closure may be formed with one or more apertures which are occluded by one or more layers of permeable material bonded or heat sealed to the inner or outer surface of the closure body. The permeable material may for example comprise biaxially oriented polypropylene (BOPP) which is able to be autoclaved for sterilization of the assembled closure while being heat sealable to a polypropylene closure body.

One example of a suitable hydrophobic and permeable material is biaxially oriented polypropylene (BOPP) laminate comprising film co-extruded on one or both sides with polyolefinic copolymers forming a heat sealable layer. Such films find applications based on the gas permeability properties, such as improving the shelf life of fresh produce and other applications requiring a high gas transfer rate. Typical values are an overall thickness of about 35 μm, yielding 31.4 m² kg⁻¹ and having permeabilities (24 hr) of 2.7 Lm⁻² (O₂) and 10.8 Lm⁻² (CO₂). Water vapour permeability varies from 0.8 gm⁻² per 24 hrs at 23° C. and 85% RH to 6.0 gm⁻² per 24 hrs at 38° C. and 90% RH.

The containers and closures in assembly may be shipped with the plantlet holder matrix installed, either preloaded with or ready to accept the nutrient medium.

In another aspect the present invention resides broadly in robotic plantlet handling apparatus including:
a workstation having an operator work portion, a material source portion, a material delivery portion and a robot arm;
at least one housing located at the material source portion and containing a plurality of plantlet holders formed of nutrient solution-absorbing material and each comprising an upper portion with an insertion point at its top for inserting a plantlet and a lower portion adapted to locate in an opening in a support, the upper portion having an outer wall surface forming a handling portion adapted to be frictionally gripped for handling, the housing being closable by a lid having a complementary engagement periphery adapted to mechanically and sealingly engage a corresponding peripheral lip of the housing;
at least one said housing located at said material delivery portion and adapted to receive a plurality of said plantlet holders; and
a plantlet holder manipulator on said robot arm and adapted to engage said handling portion for movement of a plantlet holder between said material source portion, said operator work portion, and said material delivery portion.

The workstation is generally a clean space where substantially sterile materials may be handled. For example the workstation may comprise a workstation enclosure such as positive pressure, laminar flow or glove box enclosure.

The operator work portion may include one or more work stands adapted to receive and retain a plantlet holder for a worker to operate on the plantlet in the holder. The work stands may include a handling portion engagement portion adapted to cooperate with a complementary engagement portion on the handling tab of the plantlet holder. The operator work portion may include lighting. The operator work portion may include robot operating controls and/or overrides. The operator work portion may include a plant tissue and nutrient waste and reject holder disposal means. The operator work portion may comprise a hinged platform mounting the work stands and movable to permit changing out of a waste and reject holder located beneath an opening in the platform. The hinge may be configured to release the platform at a selected angle.

The operator work portion may include a plurality of work stands each including operator prompt means adapted to cause the operator to time actions in concert with the robot arm. The operator prompt means may comprise one or more LED indicators operated by control means associated with the robot arm.

There may be provided latch means allowing the work stand to be selectively released from the operator work portion for maintenance, cleaning or replacement. The work stand includes a plantlet holder support portion adapted to receive and retain a plantlet holder. For example the work stand may include an upper ring adapted to receive a plantlet holder and support same with the insertion point and handling portion above the ring.

The operator work portion may comprise one or more work stands each having an aperture selected to receive a plantlet holder and associated with support means for presenting the handling portion above the aperture. The handling portion and lower portion may be mutually formed as an integral body of constant cross section extending from said upper end, and wherein the support means may comprise a step portion associated with the work stand on which a lower end of the lower portion locates.

The material source portion may include an array of housings. The array of housings may include location means for the respective housings to assist the robot arm operation by location of the plantlet holders within tolerance of discrete positions. The material source portion may include a closure locator to allow for storage of a lid removed from a housing and/or spare closures. The material source portion may include storage for spare plantlet holders.

The material delivery portion may include space for an array of housings. The array of housings may include location means for the respective housings to assist the robot arm operation by providing discrete locations for the plantlet holders. The material source portion may include a lid locator to allow for storage of a lid to be fitted to a housing and/or spare lids.

The workstation may include other portions selected from but not limited to a hand tool storage portion and a tool sterilization bath portions.

The robot arm may comprise a multi-axis robot arm controlled by a robotic controller and terminating in the plantlet holder manipulator. The plantlet holder manipulator may comprise a gripper assembly having a pair of jaws adapted to engage the handling portion of the plantlet holder and selectively operable under robotic control by means such as electromechanical or pneumatically actuator. The end portions of the gripper arms may be provided with a friction-modifying coating or sheathing to optimise plantlet holder handling.

The gripper assembly may be mounted on the robot arm on a rotatable cuff to enable selective deployment of the grippers by rotation of the cuff. The handling portion may be polygonal and the jaws may be of a complementary shape. In this case the lower portion of the jaws may relieved to enable the jaws in the closed position to pass laterally into alignment with the handling portion, open, move vertically into full overlap with the handling portion, then close to grip the handling portion. By this means, when there is a mass of plant material the gripper jaws avoid snagging the material.

The actuators of the gripper assembly may be pneumatic or electromechanical.

The housing and closure therefor may be substantially as described above.

The location means may take the form of housing holders located in a workstation/robot enclosure at the material source and delivery stations. The housing holders may take the form of an aperture plate having apertures for accepting a plurality of housings. The housing holder may include latching means to provide selectively releasable, positive retention of the housing in the housing holder. The housing may be formed with nibs formed in a side wall to cooperate with the latching means. Otherwise, the nibs may be configured to enable snap-in retention in the location means for the respective housings. The nibs may provide for handling stability, for example, when closures are being removed therefrom. The housing holder may be releasable from the workstation to change multiple housing in or out of a workstation enclosure.

Computer controlled mechanical handling means including the robotic controller may form part of an integrated plant handling apparatus including electronic control of subsystems including one or more of plantlet holder excision and assembly, sterilization of parts, mixing and dispensing of nutrient media, changeover of nutrient media, insertion of plantlets into the plantlet holder support, handling supported plantlet holders en mass or plantlet holders individually, or the like.

In a further aspect this invention resides broadly in a plant cloning method including the steps of:

(i) providing a workstation having an operator work portion, a material source portion, a material delivery portion and a robot arm;

(ii) locating in said workstation at least one housing at the material source portion and containing plantlets in a plurality of plantlet holders each formed of nutrient solution-absorbing material and comprising an upper portion with an insertion point at its top for inserting a plantlet and a lower portion adapted to locate in an opening in a support, the upper portion having an outer wall surface forming a handling portion adapted to be frictionally gripped for handling, the housing being closed by a lid having a complementary engagement periphery adapted to mechanically and sealingly engage a corresponding peripheral lip of the housing;

(iii) locating in said workstation at least one housing at said material delivery portion and adapted to receive a plurality of said plantlet holders;

(iv) removing said lid to a storage location;

(v) operating said robot arm and a plantlet holder manipulator thereon to engage the handling portion of and remove a plantlet holder from the housing at the material source portion and deliver the holder to a work stand adapted to receive and retain the plantlet holder for a worker to operate on the plantlet in the holder;

(vi) operating on the plant material to produce one or more product-containing plantlet holders;

(vii) operating said robot arm and a plantlet holder manipulator thereon to engage the handling portion of and remove a plantlet holder from a work stand to a said housing at said material delivery portion;

(viii) repeating step (vii) to exhaust product bearing plantlet holders on work stands;

(ix) repeating steps (v) to (viii) until a said housing at said material delivery portion is loaded; and

(x) installing said lid on said loaded housing.

The methods of the present invention are amenable to robotic implementation. For example there may be provided a robotic platform comprising a six-axis robot that operates in a sterile laminar flow cabinet with suitably high precision such as 0.02 mm repeatability and speed such as up to 4.4 m/s.

For use in a cloning mode, a batch of up to nine containers (for example 216 plantlet holders) may be loaded consisting of up to three sealed containers of input plantlets (ready for subculture) that are sprayed with alcohol (surface decontamination) as they are loaded into a tray that quickly snaps into the robotic platform. Up to six output containers with empty plantlet holders are similarly inserted into trays; these are pre-absorbed with nutrient medium. The container lids may be removed to a storage area within the sterile cabinet.

In the basic cloning mode, the first two plantlet holders (with plantlets) from the first input container are, in sequence, gripped by the robotic fingers and transferred to two corresponding plantlet holder-stands where they are suspended in front of the operator, alongside two output plantlet holders similarly transferred from the first output container. The operator readily excises a shoot (or other tissue) from the first input plantlet and transfers this to the first output plantlet holder, and signals completion using foot or other controls.

The robot fingers grip the finished output plantlet holder and quickly returns this to an empty position in the output container, then return with a replacement plantlet holder. Similarly, when all available dissections have been made from the first input plantlet holder, the operator may signal this with foot or other controls, and it is removed to the input container, and replaced. The operator thereby may always have at least one input plantlet and one empty output plantlet holder available to continue working, with the robot removing and replacing these as signalled.

While a cycle time of about six seconds is short, the operator is not rushed but has only to make the key dissection in a very accessible position, and directly controls the timing.

There may be several other options within the cloning program. Different types of explants may grow differently, so that separation is desirable. For example, micro-cutting methods typically produce tips and nodes; tips will root more rapidly and grow vertically from the apex, whereas with nodes rooting is often delayed until an axillary shoot develops, which will be at an angle to the stem, and multiple shoots often form. The present system allows optional grading of input and output plants.

A graphic interface may report progress in plan view. For example, a screen image may be placed for dissection and may visually illustrate status. The system may also facilitate rapid grading without dissection, such as for quality control and consolidation before shipping. The cycle time for grading is typically under three seconds per plantlet. Image-processing for automatic grading may also be included.

One feature of the system is the ability to change medium, and this may be performed with minimal operator input. Input containers and corresponding receiving containers with the new (liquid) medium are loaded and positions designated and viewable in the screen image. Feedback on progress is also provided graphically. Transfer time may be approximately three seconds per plantlet, and operators can attend to other duties while a set of four pairs of containers are transferred. Speed and other variables are readily adjusted through a configuration page.

The robotic system also may provide data and image collection capability, allowing tracking of individual plantlets through all subcultures through to nursery transfer. Such tracking may provide clients with data for further improvement of subculture and growth regimes. It may also provide a management tool to flag time and location for collection of plantlets for dissection or other transfers, and monitoring of operator performance for positive feedback.

### BRIEF DESCRIPTION OF THE DRAWINGS

The invention will be described with reference to the following non-limiting embodiment of the invention as illustrated in the drawings and wherein:

FIG. 1 is a perspective view of a robotic arrangement for use with the plantlet holder of the present invention;

FIG. 2 is a detail view of the work stand portion of the apparatus of FIG. 1 in use;

FIG. 3 is a detail view of a work stand for use with the apparatus of FIG. 1;

FIG. 4 is a detail view of a plantlet holder in accordance with the present invention;

FIG. 5 is an exploded perspective view of a plantlet handling system in accordance with the present invention;

FIG. 6 is a detail view of a work stand portion of an alternative embodiment, in use;

FIG. 7 is a detail view of a plantlet holder in a workstand for use in the embodiment of FIG. 6;

FIG. 8 is a detail view of a work stand for use with the apparatus of FIG. 6;

FIG. 9 is a detail view of a plantlet holder for use with the apparatus of FIG. 6;

FIG. 10 is an exploded perspective view of a plantlet handling system in accordance with the embodiment of FIG. 6; and

FIG. 11 is an exploded view of a pair of gripper manipulator arms suitable for use in the embodiment of FIG. 6.

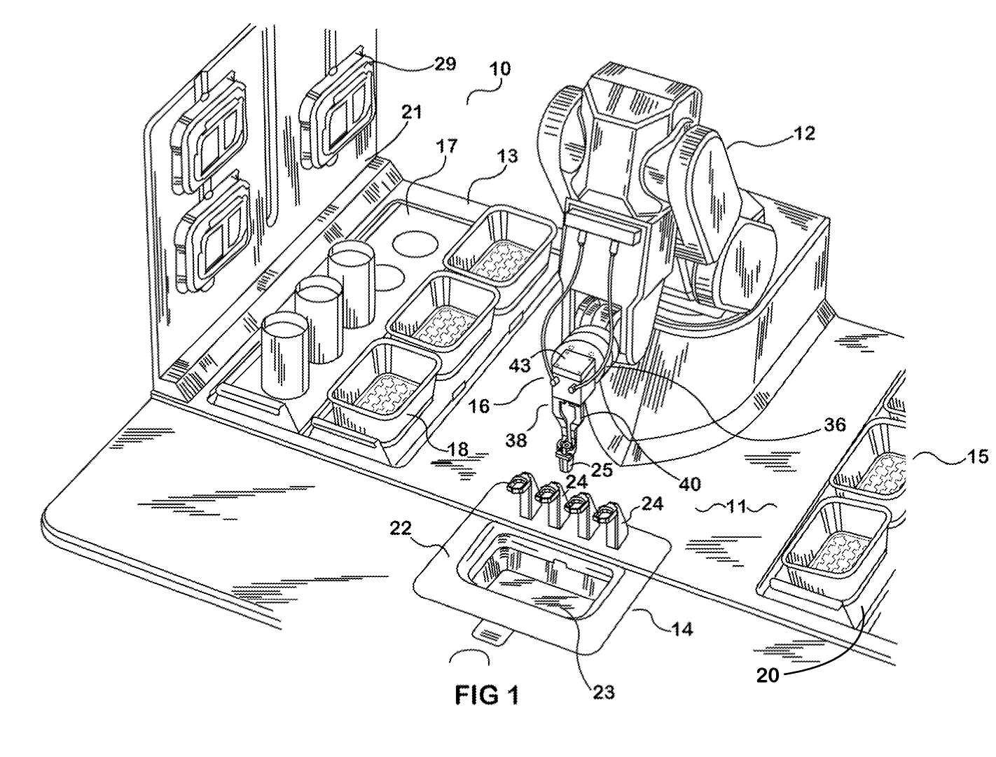

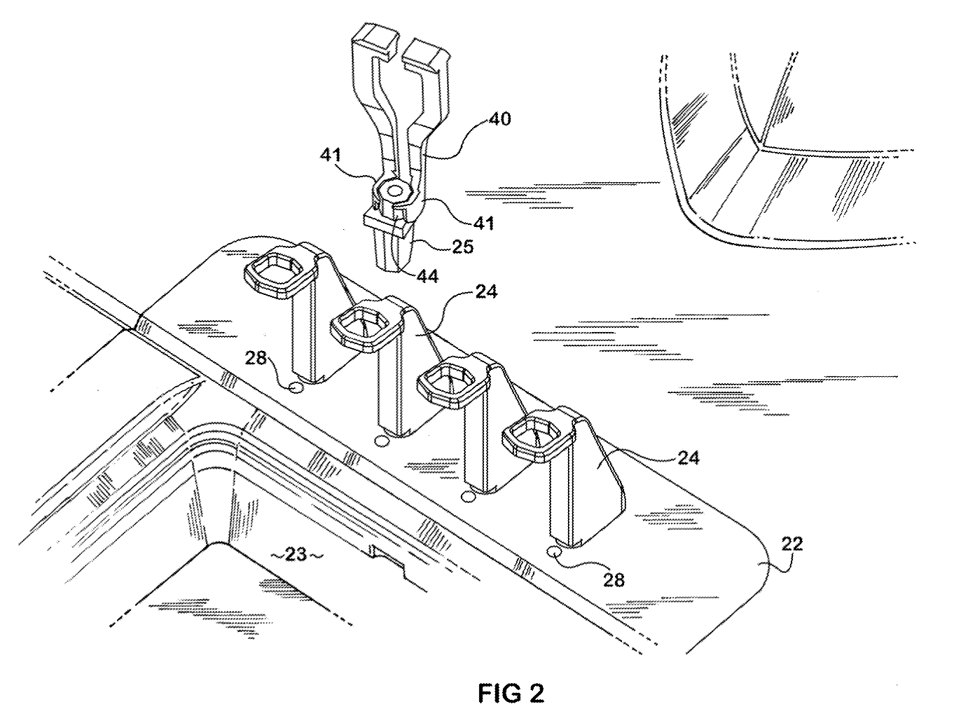

In FIGS. 1 and 2 there is illustrated the workstation 10 with the laminar-flow cabinet substantially cut-away for clarity. A platform 11 mounts a multi-axis robotic arm 12 located within an array comprising a material source portion 13, an operator workstation portion 14 and a delivery portion 15. The robot arm 12 mounts a tool assembly 16 described in detail hereinafter.

The material source portion 12 includes a removable, apertured plate 17 having wells for locating plantlet handling containers 18. The delivery portion 15 has a removable, apertured plate 20 having wells for locating plantlet handling containers to be filled. A lid storage plate 21 stores closure assemblies 29 for closing the housings 18 when filled.

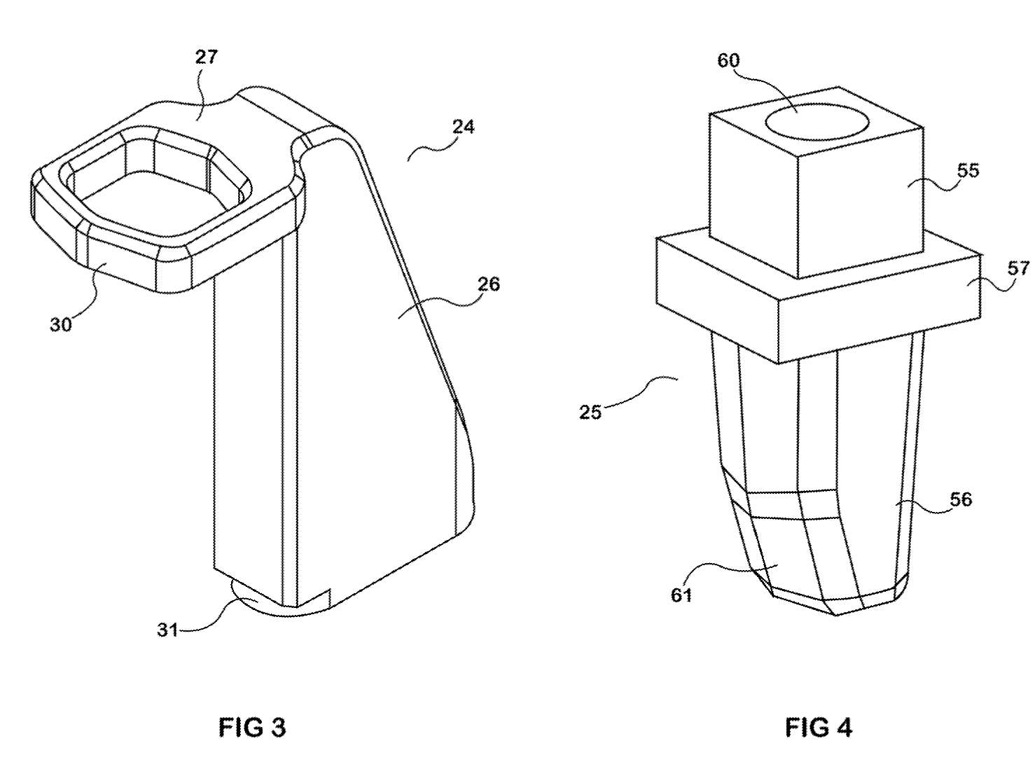

The operator portion 14 comprises a hinged and removable plate 22 having a waste well including a disposable waste container 23. Four work stands 24 (illustrated in more detail in FIG. 3) are adapted to receive plantlet holders 25 described in more detail hereinafter. The plate 22 has an LED indicator 28 corresponding to each work stand 24, the respective LED indicators 28 being collectively wired to a quick release connector (not shown) to permit removal of the plate 22.

As illustrated in FIG. 3, the work stand 24 includes a body 26 releasably secured to the plate 22 and having an overhanging upper portion 27. A ring 30 is adapted to receive a plantlet holder 25. An undercut engagement portion 31 cooperates with the platform 22 to locate the work stand.

The tool head 16 includes a rotating tool mount 36 rotatable relative to the robot arm 12. The rotating tool mount 36 mounts a tool assembly 38 consisting of a pair of gripper manipulator arms 40. The arms 40 each have a gripper end 41. The arms 40 are actuated by a pneumatic actuator 43. The gripper ends 41 are configured in this embodiment to grip a hexagonal section and are relieved at 44 to allow an “in-and-down” engagement with the plantlet holder 25, found to be most useful when the plant material is crowded over the plantlet holder 25.

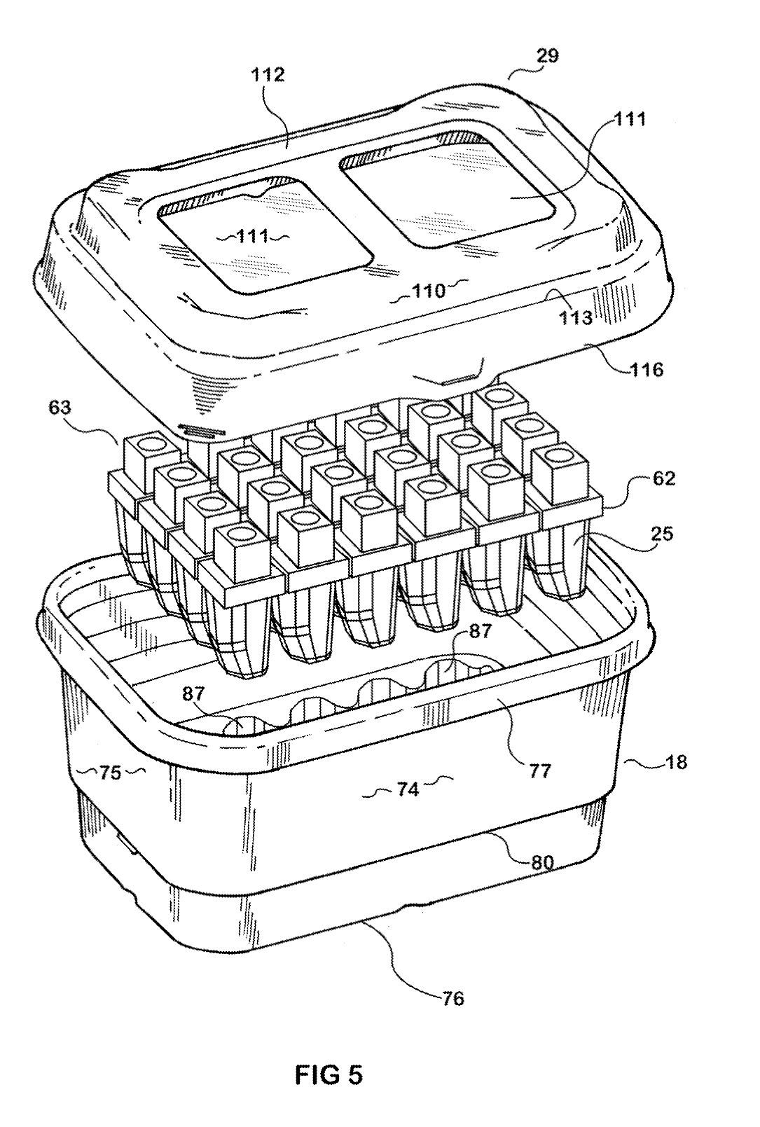

In the embodiment of FIGS. 4 and 5 there is provided a plantlet handling apparatus, wherein FIG. 4 is a variation on a plantlet holder 25 having a square handling portion and FIG. 5 is of the apparatus in context, including a housing 18 formed of a light-transmitting polypropylene, a plurality of the plantlet holders 25, and a closure assembly 29.

A unitary phenolic open-celled foam plantlet holder 25 comprises an upper handling portion 55, a lower portion 56 and a support portion 57. The upper handling portion 55 is of square section and has a plantlet insertion well 60 formed therein and extending down through the plantlet holder to a blind end within the lower portion 56. The lower portion 56 is asymmetric in that a front portion 61 is relieved toward its lower end to allow it to clear features of its environment on arcuate movement.

The support portion 57 supports the plantlet holder 25 in the ring 30 and is formed of the residue of a frangible web 62 binding a matrix 63 of twenty-four plantlet holders 25, as seen in FIG. 5.

In the assembly of a plant handling apparatus of FIG. 5, the housing 18 comprises side 74 and end 75 walls which are divergent up from a base wall 76 to provide for stackability of the housings 18. The upper edges 77 of the side and end walls form a reinforced edge including a mechanical engagement for the closure assembly 29. There is provided a step 80 in the side 74 and end 75 walls and providing an annular land on the inside of the housing 18. The base wall 76 is formed with re-entrant portions which enable the apparatus to be stacked complete with inserted plantlet holders 25 for shipping.

The base wall of the housing 18 has integrally formed plantlet holder support wells 87 in array and shaped to accept the plantlet holders 25 and providing positive orientation of the plantlet holder 25. The spacing of the wells 87 is selected to break apart the matrix 63 on insertion.

The closure assembly 29 comprises a polypropylene moulded body portion 110 having formed in the upper surface a pair of windows 111 formed in a raised portion 112 which provides some stiffening of the upper surface. The upper surface is bounded by a peripheral stiffening ridge 113.

An outer flange 116 extends down past the upper edge 77 in use to define a dead space which resists convection mixing.

The windows 111 are closed off by a biaxially oriented polypropylene (BOPP) film heat sealed to the raised portion 112 in order to provide a closure assembly that is substantially sealed to the housing to reduce the risk of biological contamination while permitting exchange of metabolic gases.

The containers 18 and closures 29 in assembly may be shipped with the matrix 63 installed, either preloaded with or ready to accept the nutrient medium.

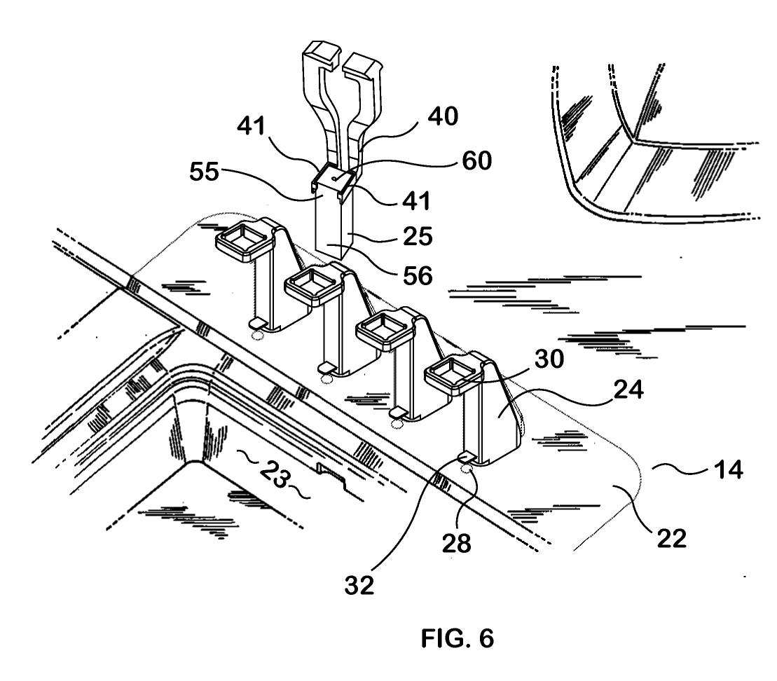

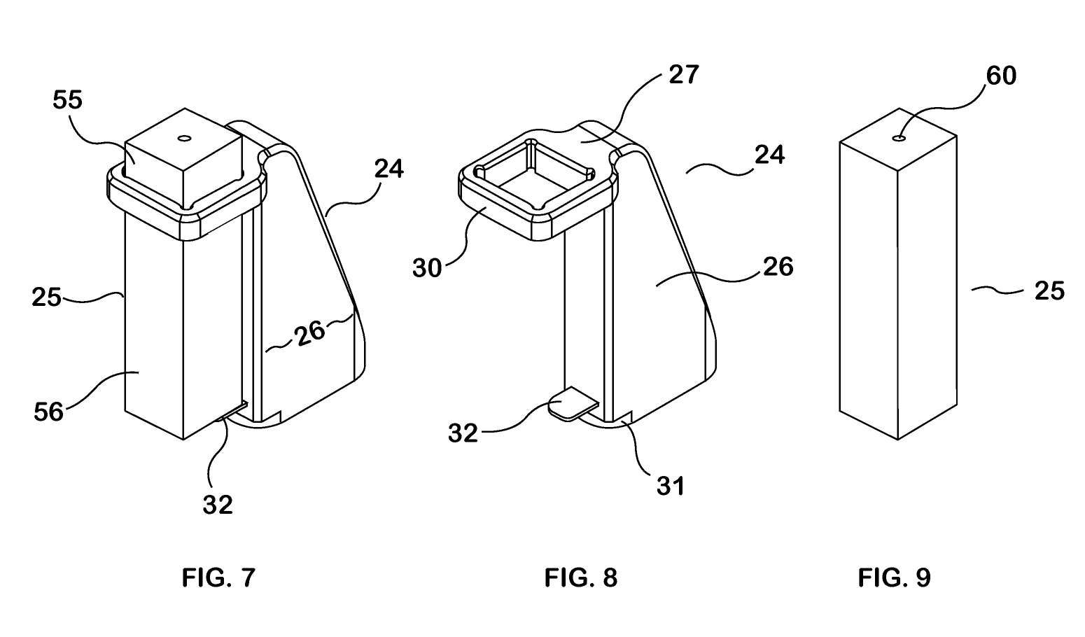

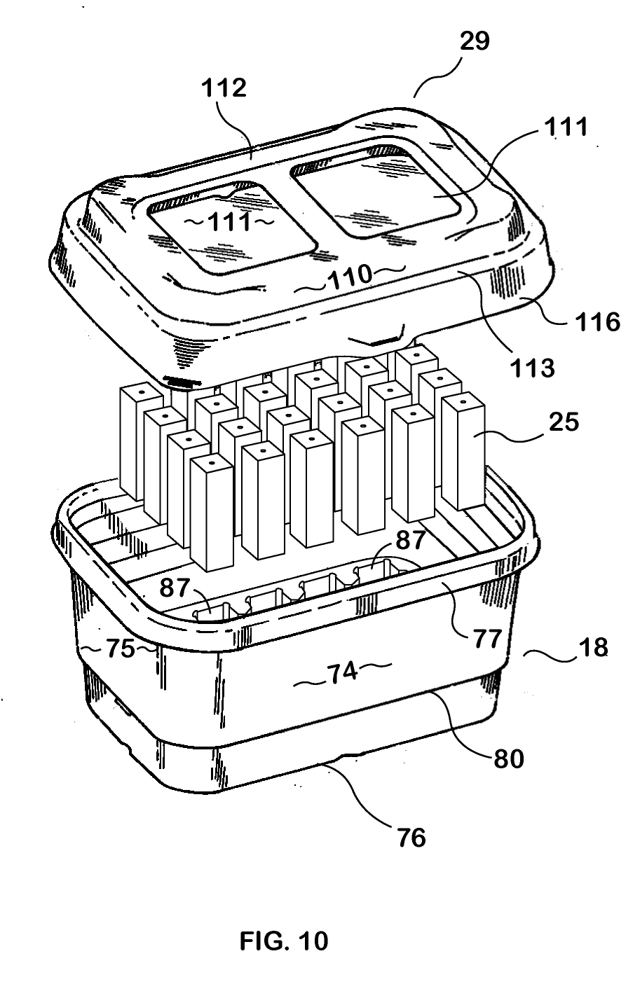

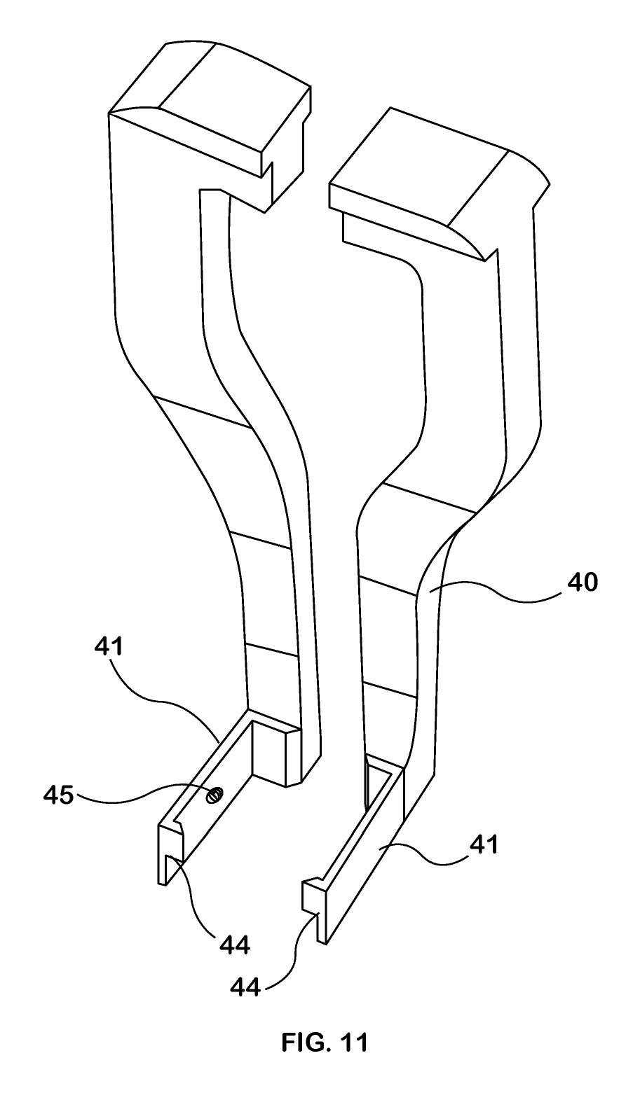

In the alternative embodiment of FIGS. 6 to 11, where like details are numerated as per FIGS. 1 to 5, the four work stands 24 (illustrated in more detail in FIGS. 7 and 8) are adapted to receive phenolic foam plantlet holders 25 described in more detail hereinafter.

As illustrated in FIGS. 7 and 8, the work stand 24 includes a ring 30, in this embodiment adapted to receive a plain square section plantlet holder 25. The plain square section plantlet holder 25 is located as to height by resting on a step portion 32.

In this embodiment a pair of gripper manipulator arms 40 each have a gripper end 41. The gripper ends 41 are configured in this embodiment to grip a square section and are relieved at 44 to allow an “in-and-down” engagement with the plantlet holder 25, found to be most useful when the plant material is crowded over the plantlet holder 25. A locating nib 45 on the gripping face of each gripper end 41 penetrates the phenolic foam surface of the handling portion 55 in use, providing positive location of the plantlet holder 25 in its manipulations. The nib 45 is domed and about 2 mm diameter and less than 1 mm height

A unitary phenolic open-celled foam plantlet holder 25 is of constant square cross section.

Apparatus in accordance with the foregoing embodiments are mechanical devices that support individual tissue culture plantlets, allowing them to be readily handled as individuals for transfers between tissue culture flasks, and transfer ex-vitro to soil or other growing medium. The plantlet holder provides a solid projection for mechanical gripping and movement of individual plantlets without touching the plantlet shoots or roots directly.

While illustrated with application of micro-propagation methods, the plantlet holder system is applicable to many types of plant tissue culture, including organogenesis or somatic embryogenesis, and to transformation/regeneration systems. The plantlet holder system can be used with manual methods of handling using forceps and similar gripping tools; the system is also suitable for machine controlled tools to facilitate mechanized handling methods.

The components of the robotic consumables facilitate positioning and handling features for rapid loading of the custom robotic platform and removal and storage of lids. All components have been designed for manufacturing and assembly efficiency, and will nest and stack in all assembly variations for volume efficiency in transport, sterilisation, media filling, and laboratory storage and tissue culture growth. Space efficiency is high with typical growing density (per layer) of 1000 plantlets/m².

The present plantlet holder system enables rapid and efficient robotic handling. Plantlets are conveniently presented to operators in an ergonomically appropriate way for easy dissection and transfer, with presentation interval of approximately six seconds. Operator efficiency is increased about five-fold over conventional tissue culture. These capabilities of the present system provide a powerful platform that radically changes the efficiency, capacity, quality and management of plant tissue culture operations. It is adaptable to different plant architectures, making it suitable for most, if not all, tissue culture systems. The flexible control of growth conditions may also make tissue culture successful with targets that are otherwise recalcitrant. More importantly, with the price sensitivity of many prospective targets, cost reductions possible from the present system can dramatically increase market demand.

It will of course be realised that while the above has been given by way of illustrative example of this invention, all such and other modifications and variations thereto as would be apparent to persons skilled in the art are deemed to fall within the broad scope and ambit of this invention as is set forth herein.

1-37. (canceled)

38. A plantlet handling system including:
a plurality of plantlet holders each formed of open-celled phenolic foam and comprising an upper portion with a plantlet insertion well in its upper end and a lower portion adapted to locate in an opening in a support, the upper portion having an outer wall surface forming a handling portion adapted to be frictionally gripped for robotic or manual handling;
a housing adapted to order the plantlet holders and maintain immersion in nutrient solution in use;
a lid having a complementary engagement periphery adapted to mechanically and sealingly engage a corresponding peripheral lip of the housing to provide an enclosure in which sterility may be maintained.

39. The plantlet handling system according to claim 38 wherein the housing comprises a tub or tray including integral wells each configured to provide said support for a plantlet holder.

40. The plantlet handling system according to claim 38 wherein the lid includes a relatively deep peripheral flange that extends downward of the housing lip to define an annular dead space that is not subject to convection mixing with the environment.

41. The plantlet handling system according to claim 38 wherein the closure is selectively permeability to metabolic gases produced or required by plantlets by means of inclusion of a gas permeable portion of the closure, the gas permeable portion being selected from cellulosic non-woven material having a proportion of polyolefin fibre therein and axially oriented crystalline polyolefins.

42. The plantlet handling system according to claim 41 wherein the gas permeable portion comprises biaxially oriented polypropylene (BOPP).

43. A robotic plantlet handling apparatus including:
a workstation having an operator work portion, a material source portion, a material delivery portion and a robot arm;
at least one housing located at the material source portion and containing a plurality of plantlet holders;
at least one said housing located at said material delivery portion and adapted to receive a plurality of said plantlet holders; and
a plantlet holder manipulator on said robot arm and adapted to engage said handling portion for movement of a plantlet holder between said material source portion, said operator work portion, and said material delivery portion, said plantlet holders each being formed of open-celled phenolic foam and comprising an upper portion with a plantlet insertion well in its upper end and a lower portion adapted to locate in an opening in a support, the upper portion having an outer wall surface forming a handling portion adapted to be frictionally gripped by said robotic arm for handling.

44. The robotic plantlet handling apparatus according to claim 43 wherein the robot arm comprises a multi-axis robot arm controlled by a robotic controller and terminating in the plantlet holder manipulator.

45. The robotic plantlet handling apparatus according to claim 43 wherein the plantlet holder manipulator comprises a gripper assembly having a pair of jaws adapted to engage the handling portion of the plantlet holder and selectively operable between an open and closed position under robotic control by a pneumatic actuator.

46. The robotic plantlet handling apparatus according to claim 45 wherein a lower portion of the jaws is relieved to enable the jaws in the closed position to pass laterally into alignment with the handling portion, open, move vertically into full overlap with the handling portion, then close to grip the handling portion.

47. The robotic plantlet handling apparatus according to claim 43 wherein the operator work portion comprises one or more work stands each having an aperture selected to receive a said plantlet holder and associated with support means for presenting said handling portion above said aperture.

48. The robotic plantlet handling apparatus according to claim 47 wherein the handling portion and lower portion are mutually formed as an integral body of constant cross section extending from said upper end, and wherein said support means comprises a step portion associated with said work stand on which a lower end of said lower portion locates.

49. A plant cloning method including the steps of:
(i) providing a workstation having an operator work portion, a material source portion, a material delivery portion and a robot arm;
(ii) locating in said workstation at least one housing at the material source portion and containing plantlets in a plurality of plantlet holders, said plantlet holders each being formed of open-celled phenolic foam and comprising an upper portion with a plantlet insertion well in its upper end and a lower portion adapted to locate in an opening in a support, the upper portion having an outer wall surface forming a handling portion adapted to be frictionally gripped by said robotic arm for handling, the housing being closed by a lid having a complementary engagement periphery adapted to mechanically and sealingly engage a corresponding peripheral lip of the housing;
(iii) locating in said workstation at least one other said housing at said material delivery portion and adapted to receive a plurality of said plantlet holders;
(iv) removing said lid to a storage location;
(v) operating said robot arm and a plantlet holder manipulator thereon to engage the handling portion of and remove a plantlet holder from the housing at the material source portion and deliver the holder to a work stand adapted to receive and retain the plantlet holder for a worker to operate on the plantlet in the holder;
(vi) operating on the plant material to produce one or more product-containing plantlet holders;
(vii) operating said robot arm and a plantlet holder manipulator thereon to engage the handling portion of and remove a plantlet holder from a work stand to a said housing at said material delivery portion;
(viii) repeating step (vii) to exhaust product bearing plantlet holders on work stands;
(ix) repeating steps (v) to (viii) until a said housing at said material delivery portion is loaded; and
(x) installing said lid on said loaded housing.
